(19) United States
(12) Patent Application Publication
(10) Pub. No.: US 2025/0063006 A1
(43) Pub. Date: Feb. 20, 2025

(54) VISUAL MEDIA-BASED CHATBOT

(71) Applicant: Jia Xu, Hoboken, NJ (US)

(72) Inventor: Jia Xu, Hoboken, NJ (US)

(21) Appl. No.: 18/809,208

(22) Filed: Aug. 19, 2024

Related U.S. Application Data
(60) Provisional application No. 63/533,494, filed on Aug. 18, 2023.

(51) Int. Cl. H04L 51/04; H04L 51/02; H04L 51/10

(52) U.S. Cl. CPC H04L 51/04; H04L 51/02; H04L 51/10

(57) ABSTRACT

A method for operating a chatbot stores, using a database, a plurality of visual media and metadata corresponding to each of the plurality of visual media. The method receives verbal input from a user. The method determines a visual media query as a function of the verbal input. The method assigns confidence scores as a function of the visual media query and the metadata corresponding to each of the plurality of visual media. The method determines a visual media selection using the confidence scores. The method outputs the visual media selection and a corresponding verbal response.

### PRIORITY

This patent application claims priority from provisional U.S. patent application No. 63/533,494, filed Aug. 18, 2023, entitled, “VIDEO AND IMAGE ENHANCED CHATBOT,” and naming Jia Xu as inventor, the disclosure of which is incorporated herein, in its entirety, by reference.

### FIELD

Illustrative embodiments of the invention generally relate to chatbots and chatbot interfaces. More particularly, various embodiments of the invention relate to enhancing chatbot communication with integrated visual media, including automated generation and display of relevant images and videos in response to user interactions, in both 2D and 3D formats.

### BACKGROUND

Chatbots may be used for simulating conversation with human users, as well as providing assistance, information, or facilitating services across various digital platforms, among other things. They serve to streamline customer service, enhance user engagement, automate routine inquiries, support sales and marketing strategies, and offer quick access to information. This can include tasks like answering FAQs, guiding users through website navigation, helping with shopping or bookings, and providing round-the-clock support in multiple languages. Conventional chatbots communicate with users by way of textual and auditory interactions.

### SUMMARY OF VARIOUS EMBODIMENTS

In accordance with one embodiment of the invention, a method for operating a chatbot stores, using a database, a plurality of visual media and metadata corresponding to each of the plurality of visual media. The method receives verbal input from a user. The method determines a visual media query as a function of the verbal input. The method assigns confidence scores as a function of the visual media query and the metadata corresponding to each of the plurality of visual media. The method determines a visual media selection using the confidence scores. The method outputs the visual media selection and a corresponding verbal response.

The plurality of visual media may have images and videos.

The metadata may have real number vectors or the visual media query may have a real number vector embedded with the verbal input. In some embodiments, the method generates a verbal output to the user, and wherein the real number vector is also embedded with the verbal response. Assigning the confidence scores may include comparing the real number vector embedded with the verbal input and the real number vectors of the metadata. Comparing may include determining a cosine similarity between the real number vector embedded with the verbal input and each real number vector of the metadata.

Assigning the confidence scores may include training an ensemble model. In some embodiments, the method retrains the ensemble model in response to receiving a second verbal input from the user, determining a chat duration, or determining a user response time.

Outputting the visual media selection may include adjusting a text appearance characteristic as a function of the visual media selection.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a flowchart showing a process for interacting with a chatbot using visual media in accordance with various embodiments.

FIG. 2 schematically shows a chatbot interface in accordance with various embodiments.

FIG. 3 is a block diagram of a computing device in accordance with various embodiments.

### DESCRIPTION OF ILLUSTRATIVE EMBODIMENTS

In illustrative embodiments, a chatbot communicates with a user using text as well as visual media, such as images or videos, among other things. Visual media is stored and made searchable in a database. As the chatbot interacts with the user, the chatbot may query the database to select a visual media to output after assigning confidence scores to each stored visual media. Details of illustrative embodiments are discussed below.

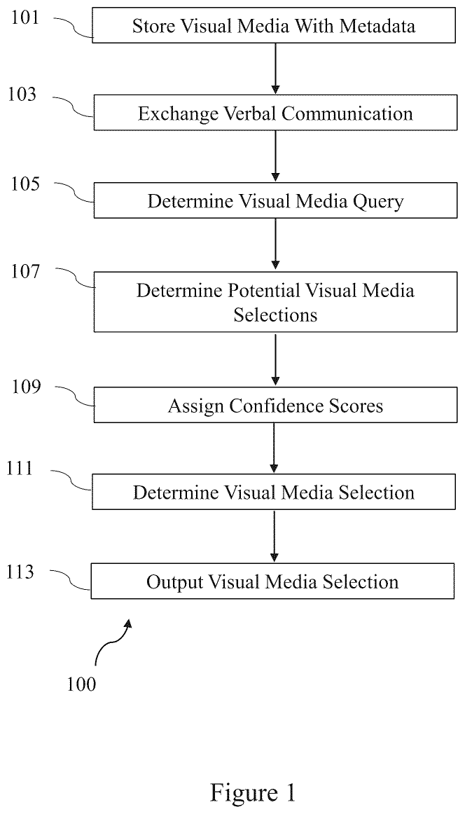

FIG. 1 shows an exemplary process 100 for operating a chatbot in accordance with an illustrative embodiment. The process 100 may be implemented in whole or in part in one or more of the computing devices disclosed herein. In certain forms, the functionalities may be performed by separate devices. In certain forms, all functionalities may be performed by the same device. It shall be further appreciated that a number of variations and modifications to the process 100 are contemplated, including, for example, the omission of one or more aspects of the process 100, the addition of further conditionals and operations, or the reorganization or separation of operations and conditionals into separate processes.

The process 100 begins by storing visual media with a database. The visual media may include images or videos. Each visual media stored in the database has corresponding metadata configured to describe attributes of the visual media and facilitate a search of the database. The metadata may include, among other things, file information (e.g., filename, file format, file size, date created, date modified); technical metadata (e.g., dimensions, color space, bitrate, frame rate for videos, duration for videos, codec); content descriptors (e.g., title, description or caption, keywords or tags, category or genre); creation details (e.g., camera or equipment used, settings used during capture, location, creator or author's name); rights and licensing (e.g., copyright holder, usage rights, license information); descriptive tags (e.g., people present, activities depicted, objects identified, landmarks, text captured); or analytical metadata (e.g., sentiment detected, scene categorization, annotations, confidence scores of detected features).

In some embodiments, the metadata is organized in the form of a vector embedding, which may be numerical representations of complex, non-numerical data. In some embodiments, the vectors are comprised of real numbers. Vector embeddings may be generated by machine learning models using vectors of real numbers, among other things. Embedded in a high-dimensional space, these vectors may encapsulate the original data's relationships and characteristics in a format suitable for computation. Vector embeddings may be generated using Word2Vec, bidirectional encoder representations (BERT), or ImageNet pre-trained models, among other things. One benefit of vector embedding is that it allows for capturing and representing the semantic relationships between words or entities in a continuous vector space. This means similar words or entities are mapped to vectors that are close to each other, enabling more effective processing and understanding of natural language by machine learning models. This facilitates tasks like searching the database, recommendation, and clustering by making it easier to identify and work with related concepts.

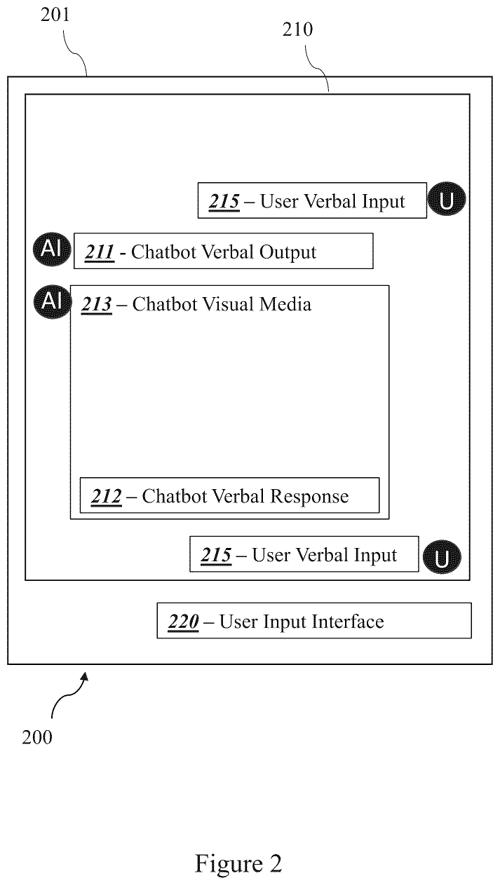

The process 100 proceeds to operation 103 where the user communicates verbally (i.e., using words) with the chatbot. The verbal communications between the user and the chatbot may be using text or audio. A visual representation of the communication is shown in FIG. 2, where a screen 201 is configured to display a chatbot interface 200. The chatbot interface 200 includes a conversation history section 210 configured to display communications between the user and the chatbot, as well as a user input interface 220 configured to receive verbal input from the user, which may be in the form of audio recordings or text, among other things.

As the user provides input to the chatbot, illustrated as user verbal input 215, the process 100 determines and outputs responses, illustrated as chatbot verbal output 211, based on the user input and the context of the conversation (i.e., previous user inputs and chatbot responses).

In some embodiments, the user verbal inputs 215 and the chatbot verbal outputs 211 are embedded into one or more vectors (e.g., real number vectors), for later comparison with embedded vectors of the stored visual media.

The process 100 proceeds to determine a visual media query for searching the database of stored visual media. The visual media query may be configured to identify visual media with characteristics related to the chatbot conversation. In some embodiments, the visual media query may be a function of the embedded vectors corresponding to the verbal inputs 215 and verbal outputs 211. In some embodiments, the process 100 may determine multiple visual media queries, such as a query for searching stored images and another query for searching stored videos.

The process 100 may determine the visual media query for deep neural networks that use embedded vectors for searching the database. For example, the process 100 may use, among other things, Siamese networks, BERT, sentence transformers (e.g., sentence-BERT), deep structured semantic models (DSSM), deep convolutional neural networks (CNNs) for image retrieval, variational autoencoders (VAEs), neural collaborative filtering (NCF), or recurrent neural networks (RNNs) for sequence embeddings.

The process 100 proceeds to determining potential visual media selections using the results of querying the databases using the queries determines in operation 105. In some embodiments, potential visual media selections may include an image stored in the database, a video stored in the database, or an aggregation of images or videos stored in the database.

In some embodiments, the potential visual media selections may be determined using cosine similarity to compare the embedded vectors of the stored visual media and the embedded vectors of the visual media query. Cosine similarity may be calculated by taking the dot product of the vectors and dividing that by the product of their magnitudes (or Euclidean norms), which effectively measures the cosine of the angle between the two vectors. A cosine value of 1 indicates that the vectors are identical in orientation, 0 indicates orthogonality (no similarity), and −1 indicates they are diametrically opposed.

In some embodiments, one or more images or videos of the database may be used as input for a deep learning model to generate a potential visual media selection. For example, the deep learning model may include one or more generative adversarial networks (GANs), variational autoencoders (VAEs), recurrent neural networks (RNNs), long short-term memory (LSTM) networks, 3D convolutional neural networks (3D CNNs), transformer models, or auto-regressive models, among other things. In this way, the chatbot may facilitate automatic image and video generation with a chat function for interactively developing the image, video, and story over time.

After determining the potential visual media selections, the process 100 assigns confidence scores to the potential visual media selections, the scores indicating the likelihood the potential visual media selection is relevant to the chatbot conversation. The process 100 may assign confidence scores as a function of the visual media query and the metadata, such as the embedded vectors, corresponding to stored visual media.

In some embodiments, the process 100 may compare a real number embedded vector of the visual media query and the real number embedded vectors of the stored visual media. For example, the process 100 may determine the distance between the visual media embedded vectors and the embedded vector of the visual media query.

Embedding distance may refer to a measure of similarity or dissimilarity between two data points after they have been transformed into a high-dimensional space known as an embedding space. The embedded vector is a representation of a data point in a continuous vector space. For example, words can be represented as vectors (word embeddings) such that words with similar meanings have vectors that are close to each other in this space. If a user input is transformed into an embedding vector, the chatbot might calculate the embedding distance between this input and various stored responses, or between the input and the stored visual media. The response with the smallest distance (i.e., the most similar embedding) would indicate the highest similarity, and thus receive the highest confidence score.

The potential selections may be ordered based on the size of the calculated distance and then assigned values based on weights or a machine learning algorithm, among other things. For example, the stored video with the smallest embedding distance to the visual media query will receive the highest confidence score.

In some embodiments, the confidence score may be determined using an ensemble model to consider multiple factors. For example, the potential visual media selection may include an image selected using a visual media query for images, a video selected using a visual media query for videos, and a generated video. To select from all the potential options, the ensemble model may use weights to weigh each calculated distance or use a machine learning model. These weights or machine learning model may be updated/retrained based on conversation characteristics, such as feedback from the user, the chat duration, or the response time of the user during the chat, among other things.

After assigning confidence scores, the process 100 determines the visual media selection for displaying to the user using the confidence scores in operation 111. The process may choose based on the high score, or whether a confidence score exceeds a threshold, among other things.

The process 100 proceeds to operation 113 where the chatbot interface 200 outputs a chatbot visual media 213 and a corresponding chatbot verbal response 212. In some embodiments of operation 113, the chatbot interface 200 outputs the chatbot visual media 213, but does not output a corresponding chatbot verbal response.

The chatbot visual media includes the visual media selection determined in operation 111. As noted above, the visual media selection may include one or more images or videos. The chatbot 200 interface may also output sound corresponding to the chatbot visual media 213. The chatbot visual media 213 may appear in 2-D or 3-D.

In some embodiments, the corresponding chatbot verbal response overlaps with the visual media selection. To help distinguish the text of the chatbot verbal response when overlapped, the chatbot interface 200 may adjust an appearance characteristic of the chatbot verbal response. For example, the appearance characteristic adjustment may include a change of color or the addition of an opaque or transparent shadow, among other things.

In some embodiments, the subject matter of the chatbot verbal response is based on the metadata of the selected visual media, the content of the selected visual media, the conversation history, or the visual media query, among other things. The chatbot verbal response may be generated using deep learning models, such as convolutional neural networks (CNNs), recurrent neural networks (RNNs), long short-term memory networks (LSTMs), encoder-decoder architectures, attention mechanisms, transformer models, or sequence-to-sequence (seq2seq) models, among other things.

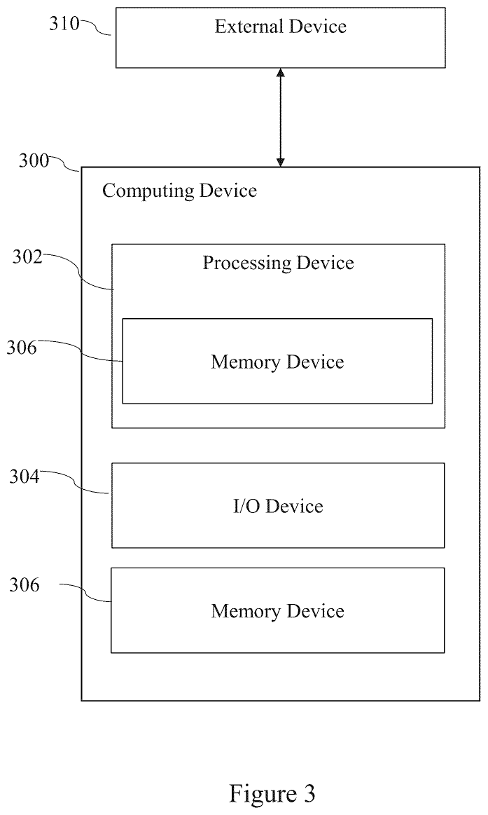

FIG. 3 schematically shows a computing device 300 in accordance with various embodiments. The computing device 300 is one example of a computing device which is used to perform one or more operations of the process 100 illustrated in FIG. 1. Among other things, the computing device 300 may include a television, a digital photo album, a home assistant device, or another type of device having a screen configured to display a visual output such as the chatbot interface 200 illustrated in FIG. 2. The computing device 300 includes a processing device 302, an input/output device 304, and a memory device 306. The computing device 300 may be a stand-alone device, an embedded system, or a plurality of devices configured to perform the functions described with respect to the process 100. Furthermore, the computing device 300 may communicate with one or more external devices 310.

The input/output device 304 enables the computing device 300 to communicate with an external device 310. For example, the input/output device 304 may be a network adapter, a network credential, an interface, or a port (e.g., a USB port, serial port, parallel port, an analog port, a digital port, VGA, DVI, HDMI, FireWire, CAT 5, Ethernet, fiber, or any other type of port or interface), among other things. The input/output device 304 may be comprised of hardware, software, or firmware. The input/output device 304 may have more than one of these adapters, credentials, interfaces, or ports, such as a first port for receiving data and a second port for transmitting data, among other things.

The external device 310 may be any type of device that allows data to be input or output from the computing device 300. For example, the external device 310 may be a database stored on another computer device, a meter, a control system, a sensor, a mobile device, a reader device, equipment, a handheld computer, a diagnostic tool, a controller, a computer, a server, a printer, a display, a visual indicator, a keyboard, a mouse, or a touch screen display, among other things. Furthermore, the external device 310 may be integrated into the computing device 300. More than one external device may be in communication with the computing device 300.

The processing device 302 may be a programmable type, a dedicated, hardwired state machine, or a combination thereof. The processing device 302 may further include multiple processors, Arithmetic-Logic Units (ALUs), Central Processing Units (CPUs), Digital Signal Processors (DSPs), or Field-programmable Gate Arrays (FPGA), among other things. For forms of the processing device 302 with multiple processing units, distributed, pipelined, or parallel processing may be used. The processing device 302 may be dedicated to performance of just the operations described herein or may be used in one or more additional applications. The processing device 302 may be of a programmable variety that executes processes and processes data in accordance with programming instructions (such as software or firmware) stored in the memory device 306. Alternatively or additionally, programming instructions are at least partially defined by hardwired logic or other hardware. The processing device 302 may be comprised of one or more components of any type suitable to process the signals received from the input/output device 304 or elsewhere, and provide desired output signals. Such components may include digital circuitry, analog circuitry, or a combination thereof.

The memory device 306 in different embodiments may be of one or more types, such as a solid-state variety, electromagnetic variety, optical variety, or a combination of these forms, to name but a few examples. Furthermore, the memory device 306 may be volatile, nonvolatile, transitory, non-transitory or a combination of these types, and some or all of the memory device 306 may be of a portable variety, such as a disk, tape, memory stick, or cartridge, to name but a few examples. In addition, the memory device 306 may store data which is manipulated by the processing device 302, such as data representative of signals received from or sent to the input/output device 304 in addition to or in lieu of storing programming instructions, among other things. As shown in FIG. 3, the memory device 306 may be included with the processing device 302 or coupled to the processing device 302, but need not be included with both.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims. It shall nevertheless be understood that no limitation of the scope of the present disclosure is hereby created, and that the present disclosure includes and protects such alterations, modifications, and further applications of the exemplary embodiments as would occur to one skilled in the art with the benefit of the present disclosure.

What is claimed is:

1. A method for operating a chatbot, comprising:
storing, using a database, a plurality of visual media and metadata corresponding to each of the plurality of visual media;
receiving verbal input from a user;
determining a visual media query as a function of the verbal input;
assigning confidence scores as a function of the visual media query and the metadata corresponding to each of the plurality of visual media;
determining a visual media selection using the confidence scores; and
outputting the visual media selection and a corresponding verbal response.

2. The method of claim 1, wherein the plurality of visual media includes images and videos.

3. The method of claim 1, wherein the metadata includes real number vectors.

4. The method of claim 3, wherein the visual media query includes a real number vector embedded with the verbal input.

5. The method of claim 4, comprising generating a verbal response to the user, and wherein the real number vector is also embedded with the verbal response.

6. The method of claim 4, wherein the assigning the confidence scores include comparing the real number vector embedded with the verbal input and the real number vectors of the metadata.

7. The method of claim 6, wherein the comparing includes determining a cosine similarity between the real number vector embedded with the verbal input and each real number vector of the metadata.

8. The method of claim 1, wherein assigning the confidence scores includes training an ensemble model.

9. The method of claim 8, comprising retraining the ensemble model in response to receiving a second verbal input from the user, determining a chat duration, or determining a user response time.

10. The method of claim 1, wherein outputting the visual media selection includes adjusting a text appearance characteristic as a function of the visual media selection.

11. A computer program product for use on a computer system for operating a chatbot, the computer program product comprising a tangible, non-transient computer-usable medium having computer-readable program code thereon, the computer readable program code comprising:
program code for storing, using a database, a plurality of visual media and metadata corresponding to each of the plurality of visual media;
program code for receiving verbal input from a user;
program code for determining a visual media query as a function of the verbal input;
program code for assigning confidence scores as a function of on the visual media query and the metadata corresponding to each of the plurality of visual media;
program code for determining a visual media selection based on the confidence scores; and
program code for outputting the visual media selection and a corresponding verbal response to the user.

12. The computer program product of claim 11, wherein the plurality of visual media includes images and videos.

13. The computer program product of claim 11, wherein metadata includes real number vectors corresponding to each of the plurality of visual media.

14. The computer program product of claim 13, wherein the visual media query includes a real number vector embedded with the verbal input.

15. The computer program product of claim 14, wherein the program code further comprises program code for generating a verbal output to the user, wherein the verbal output is also embedded into the real number vector.

16. The computer program product of claim 14, wherein assigning the confidence scores includes comparing the real number vector of the verbal input with the real number vectors of the metadata.

17. The computer program product of claim 16, wherein assigning the confidence scores includes determining a cosine similarity between the real number vector of the verbal input and each real number vector of the metadata.

18. The computer program product of claim 11, wherein assigning the confidence scores includes training an ensemble model.

19. The computer program product of claim 18, wherein the program code further comprises program code for retraining the ensemble model after receiving a subsequent verbal input from the user, determining a chat duration, or determining a user response time.

20. The computer program product of claim 11, wherein outputting the visual media selection and the corresponding verbal response includes adjusting a text appearance characteristic based on the visual media selection.
